(19) United States
(12) Patent Application Publication
(10) Pub. No.: US 2002/0010304 A1
(43) Pub. Date: Jan. 24, 2002

(54) Low temperature cure MDI prepolymers

(76) Inventor: Jay A. Johnston, Clinton Twp, MI (US)

Correspondence Address: Patent Counsel, Huntsman Polyurethanes, 286 Mantua Grove Road, West Deptford, NJ, 08066-1732, US

(21) Appl. No.: 09/813,406

(22) Filed: Mar. 21, 2001

Related U.S. Application Data
(60) Provisional application No. 60/191,555, filed on Mar. 23, 2000.

(51) Int. Cl. C08G 18/36

(52) U.S. Cl. 528/78

(57) ABSTRACT

Prepolymer and coating compositions which moisture cure in less than about 24 hours. The prepolymers have a functionality of about 1.6 to about 2.4. Reaction systems for forming the prepolymer and coating compositions include polyol, isocyanate, and at least di-functional, aliphatic tertiary amine which has one or more EO groups on the nitrogen atom of the amine.

This application claims the benefit under 35 U.S.C. Section 119(e) of United States Provisional Application Ser. No. 60/191,555, filed Mar. 23, 2000, entitled “Low Temperature Cure MDI Prepolymers”, the subject matter of which is herein incorporated by reference.

### BACKGROUND OF THE INVENTION

MDI-based coatings are applied to large metal structures (bridges, oil rigs, etc.). These coatings are applied in cold northern climates at temperatures as low as 20° F. These coatings must cure (dry to the touch) within 24 hours.

The art has employed a MDI based coating composition that includes a prepolymer having 16% NCO. The prepolymer is prepared by reacting MI-50 isocyanate with a 2000 MW, all PO diol in the presence of a propoxylated ethylene diamine (DABCO CL-485, quadrol). The molar ratio of PO to diamine is 5 to 1. Thin films (127μ) of this prepolymer moisture cure at 20° F. over 24 hours at 50% relative humidity. These films, however, bubble extensively at 20° F. These films when prepared at room temperature, moreover, contain even more bubbles and do not adhere well to the substrate.

A need therefore exists for a prepolymer and a coating composition which moisture cure within 24 hours at low temperatures of about 20° F. without the disadvantages of the prior art.

### SUMMARY OF THE INVENTION

The invention relates to MDI prepolymers and thin films thereof which moisture-cure at 20° F. in less than about 24 hours. The prepolymers have a functionality of about 1.6 to about 2.4, preferably about 2.0 to about 2.2, more preferably, about 2.0 to about 2.05.

The cure rates of these prepolymers are enhanced by preparing the prepolymers from reaction systems which include a polyol, an isocyanate, and an at least di-functional, aliphatic tertiary amine which has one or more EO groups on the nitrogen atom of the amine. Useful amines include C-5 amines having EO groups such as methyl diethanol amine, C-8 amines having EO groups such as bis(2-hydroxyethyl) octadecyloxypropylamine, difunctional C-18 amines having EO groups, difunctional C-22 amines having EO groups, and tetra-functional propoxylated/ethoxylated ethylene diamines. Generally, useful amines may contain one or more alkyl groups. Further, the alkyl groups may contain from 1 to 22 carbon atoms.

The prepolymers have a viscosity of about 1000 cps to about 6000 cps at room temperature, about 6% NCO to about 20% NCO, preferably about 10% NCO to about 18% NCO, more preferably about 14% NCO to about 16% NCO, most preferably about 15% NCO. The prepolymers can be formed into films which moisture cure overnight (24 hours) at 20° F. (humidity 30-70%, dry to the touch).

### DETAILED DESCRIPTION OF THE INVENTION

Glossary

1. ARCOL E-351 is a 2800 molecular weight polyoxyalkylene diol that has a hydroxyl number of 38.5-41.5 mg KOH/g from Lyondell Chemical Co.;

2. ARCOL E-381 a 2000 molecular weight polyoxyalkylene diol that has a hydroxyl number of 56.0 mg KOH/g from Lyondell Chemical Co.;

3. ARCOL LG-56 is a 3000 molecular weight polyoxypropylene polyol initiated with glycerine from Lyondell Chemical Co.;

4. ARCOL PPG-2025 is a 2000 molecular weight polypropylene glycol initiated with a diol from Lyondell Chemical Co.;

5. ARCOL PPG-3025 is 3000 molecular weight polypropylene glycol initiated with a diol from Lyondell Chemical Co.;

6. ARCOL PPG-4025 is 4000 molecular weight polypropylene glycol initiated with a diol from Lyondell Chemical Co.;

7. Methyl diethanol amine from Air Products Inc., Allentown, Pa.

8. C8 amine is Chemeen 8-2. Chemeen 8-2 is an ethoxylated octylamine from Chemax, Inc., Greenville, S.C.

9. DABCO CL 485 is a tetrafunctional propoxylated ethylene diamine from Air Products;

10. E-T-2 is an ethoxylated tallow amine from TOMAH PRODUCTS;

11. E-18-2 is bis(2-hydroxyethyl) octadecyloxypropylamine from TOMAH PRODUCTS;

12. E-22-2 Amine is an ethoxylated aliphatic amine from TOMAH PRODUCTS;

13. ETHOMEEN 18/12 from AKZO NOBEL is an ethoxylated (2) octadecylamine that has an equivalent weight of 345-370, and amine number of 156;

14. ETHOMEEN T/12 from AKZO NOBEL is an ethoxylated (2) tallowalkylamine that has an equivalent weight of 340-360, and amine number of 160;

15. MI-20 is a blend of 20% 2,4,MDI and 80% 4,4′ MDI from Huntsman Polyurethanes;

16. MI-30 is a blend of 30% 2,4′MDI and 70% 4.4′ MDI from Huntsman Polyurethanes;

17. MI-50 is a blend of 50% 2,4′MDI and 50% 4.4′ MDI from Huntsman Polyurethanes;

18. MONDUR XP 7080 is an aromatic polyisocyanate prepolymer from Bayer.

19. Propomeen T12 is propoxylated tallow amine from Akzo Nobel

20. RUBINATE 9272 is an MDI based polyether prepolymer from Huntsman Polyurethanes;

21. RUBINOL F456 is a 2000 molecular weight propylene glycol initiated with a diol from Huntsman Polyurethanes;

22. SYNPERONIC T304 is an intermediate molecular weight aliphatic amine initiated polyether polyol EO/PO adduct of ethylene diamine. It has an OH value of 140-132, a molecular weight of 1650 and a total base of 8.9. It is available from Uniqema;

23. SYNPERONIC T701 is a high molecular weight aliphatic amine initiated polyether polyol EO/PO adduct of ethylene diamine. It has an OH value of 65-58, a molecular weight of 3700 and a total base of 3.5. It is available from Uniqema;

24. Triethanol amine from Huntsman Polyurethanes, Inc.

25. Unless otherwise specified, all molecular weights, equivalent weights and functionalities are number averaged for polymeric species and absolute for pure compounds.

In the present invention, prepolymers are produced from a reaction mixture which includes an isocyanate, polyol, and an at least difunctional, aliphatic tertiary amine which may have one or more EO groups attached to the nitrogen atom of the amine. Preferably, two EO groups are attached to the nitrogen atom of the amine. The amines are represented by the formula:

—NR₁R₂R₃

where R₁, R₂, and R₃ may be the same or different and may be any of substituted or unsubstituted alkyl, substituted or unsubstituted alkene, or substituted or unsubstituted alkyne, preferably C₁-C₂₂ alkyl, more preferably C₁ alkyl to C₁₈ alkyl, most preferably C₁₈ alkyl, and at least one of R₁,R₂,R₃ contains EO moieties. Moreover, R₁, R₂, and R₃ may optionally contain other tertiary nitrogen.

Isocyanates which may be used to produce the prepolymers include 4,4 MDI and blends of 4,4 MDI with 2,4 MDI. Preferably, the isocyanates are blends of 4,4 MDI with 2,4 MDI such as MI-20, MI-30, and MI-50, more preferably MI-50. Other isocyanates which may be employed include 3,3′-dimethyl-4,4′-diphenylenediisocyanate, 3,3′-dimethoxy-4,4′-bisphenylenediisocyanate, 3,3′-diphenyl-4,4′-biphenylenediisocyanate, 4,4′-biphenylene diisocyanate, 4-chloro-1,3-phenylene diisocyanate, 3,3′-dichloro-4,4′-biphenylene diisocyanate, 1,5-naphthalene diisocyanate, o- and p-methoxy isocyanate, o-diisocyanate benzyl chloride, octyl diisocyanate, octadecyl diisocyanate, ethylene diisocyanate, 1,4-tetramethylene diisocyanate, 1,6-hexamethylene diisocyanate (HDI), 2,4,4-tri-methyl-1,6-hexamethylene diisocyanate, 1,12-dodecane diisocyanate, cyclohexyl diisocyanate, cyclohexane-1,4-diisocyanate, cyclobutane-1,3-diisocyanate, cyclohexane-1,3-diisocyanate, 1-isocyanato-2-isocyanatomethyl cyclopentane, 1-isocyanato-3,3,5-trimethyl-5-isocyanatomethyl cyclohexane (isophorone diisocyanate or IPDI), 2,4′-dicyclohexylhexylmethane diisocyanate, and 4,4′-dicyclohexylmethane diisocyanate.

Polyols which may be used to prepare the prepolymers include polyester polyols, polyether diols, polyether triols, and mixtures thereof. Polyester polyols which may be used include, for example, DALTOREZ P716, DALTOREZ P779, DALTOREZ P778, DALTOREZ P725, and DALTOREZ P775; polyether diols which may be used include, for example, RUBINOL F-456, ARCOL PPG-2025, ARCOL PPG-3025, ARCOL PPG-4025, ARCOL E-351, ARCOL E-381, and ARCOL LG-56, preferably ARCOL PPG 2025 and ARCOL PPG 3025; polyether triols which may be used include, for example, RUBINOL 015, ARCOL LG 168, and ARCOL LHT 42. Polyether triols and diols may be used alone or together in the reaction systems.

Manufacture of Prepolymers

The amounts of the components employed in the reaction mixtures illustrated in the non-limiting examples below are shown in Tables 1 and 1A wherein all amounts are in wt. % based on the total weight of the reaction system.

### EXAMPLES 1-4

These Examples 1-4 Illustrate Manufacture of Prepolymers from Reaction Systems Which Employ Ethoxylated Tallow Amines Such as E-T-2.

### EXAMPLE 1

MI-30 is placed into a round-bottom flask equipped with a continue blade, stir bearing, stir shaft, addition funnel, nitrogen inlet, thermocouple, temperature controller, heating mantle and a stopper. The MI-30 then is heated to 55° C. ARCOL PPG-2025 is placed into the addition funnel and is added to the flask over 0.5 h with vigorous stirring. The resulting reaction is allowed to continue for 1 h at 70° C. Molten ethoxylated amine (E-T-2) at 46.1° C. is placed into the addition funnel and is added to the resulting reaction mixture over 0.5 h. The resulting reaction is allowed to continue for 2 h.

### EXAMPLE 2

MI-30 is placed into a round-bottom flask equipped with a continue blade, stir bearing, stir shaft, addition funnel, nitrogen inlet, thermocouple, temperature controller, heating mantle and a stopper. The MI-30 then is heated to 70° C. ARCOL PPG-2025 is placed into the addition funnel and is added to the flask over 0.5 h with vigorous stirring. The resulting reaction is allowed to continue for 0.5 h at 70° C. Molten ethoxylated amine (E-T-2) at 46.1° C. is placed into the addition funnel and is added to the resulting reaction mixture over 0.5 h. The resulting reaction is allowed to continue for 2 h while cooling to 60° C.

### EXAMPLE 3

MI-30 is placed into a round-bottom flask equipped with a stir blade, stir bearing, stir shaft, addition funnel, nitrogen inlet, thermocouple, temperature controller, heating mantle and a stopper. MI-30 then is heated to 70° C. ARCOL PPG-2025 is placed into the addition funnel and is added to the flask over 30 minutes with vigorous stirring. The resulting reaction is allowed to continue for 1 h at 70° C. to produce a prepolymer and cooled to 55° C. Molten ethoxylated amine (E-T-2) at 46.1° C. is placed into the addition funnel and then is added to the reactor over 30 min. The resulting reaction is allowed to continue for 2 h at 55° C.

### EXAMPLE 4

MI-30 (199.3 g) is placed into a round-bottom flask equipped with a stir blade, stir bearing, stir shaft, addition funnel, nitrogen inlet, thermocouple, temperature controller, heating mantle and a stopper. The MI-30 then is heated to 70° C. ARCOL PPG-2025 (296.7 gm) is placed into the addition funnel and is added to the flask over 60 minutes. The resulting reaction is continued for 2 h at 70° C. Additional MI-30 (364.4 gm) is then added to the flask. Molten ethoxylated amine (E-T-2) at 46.1° C. is placed in the addition funnel and added to the reactor over 60 min. The resulting reaction is allowed to continue for 2 h at 70° C.

### EXAMPLES 5-8

These Examples Illustrate Manufacture of Prepolymers from Reaction Systems Which Employ Ethoxylated Amines Such as bis(2-hydroxyethyl) Octadecyloxypropylamine (E-18-2).

### EXAMPLES 5-7

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 1 h with vigorous stirring. The resulting reaction is allowed to continue for 1 h at 70° C. Molten bis(2-hydroxyethyl) octadecyloxypropylamine (E-18-2) at 90° C. is placed into the addition funnel and is added to the reactor over 1 h. The resulting reaction is allowed to continue for 2 h at 70° C.

### EXAMPLE 8

429.6 gm of MI-50 is placed into a round-bottom flask equipped with a stir blade, stir bearing, stir shaft, addition funnel, nitrogen inlet, thermocouple, temperature controller, heating mantle, and a stopper. The MI-50 is heated to 70° C. ARCOL PG 2025 (282.9 gm) is placed into the addition funnel and is added over 45 minutes to the flask. The resulting reaction is allowed to continue for 2 hours at 70° C. Molten E-18-2 (94.3 g) at 70° C. is placed into the funnel. 0.8 gm of thionyl chloride is added to the flask. The E-18-2 amine is added to the flask over 30 minutes. The resulting reaction is continued for 1 hour at 70° C. The reaction exothermed to 91° C. and returned to 70° C.

### EXAMPLES 9-12

Examples 9-12 Illustrate Manufacture of Prepolymers by use of High Molecular Weight Ethoxylated Aliphatic Amines Such as E-22-2.

### EXAMPLE 9

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 70° C. ARCOL PG 2025 is placed into the addition funnel and is added over 90 minutes to react with the MI-30 in the flask. The resulting reaction is allowed to continue for 1 hour. Molten E-22-2 at 100° C. is placed in the funnel and added to the flask over 30 minutes. The resulting reaction is continued for 1 hour.

### EXAMPLE 10

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 70° C. ARCOL PG 2025 is placed into the addition funnel and is added over 90 minutes to react with the MI-30 in the flask. The resulting reaction is allowed to continue for 2 hours at 70° C. The reaction then is cooled to 45° C. Thionylchloride (0.52 gm) is added at this point. Molten E-22-2 at 100° C. then is placed in the funnel and added to the flask over 60 minutes. The resulting reaction is continued for 2 hours at 45° C.

### EXAMPLE 11

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 70° C. ARCOL PG 2025 is placed into the addition funnel and is added over 90 minutes to react with the MI-30 in the flask. The resulting reaction is allowed to continue for 2 hours. The reaction then is cooled to 45° C. Molten E-22-2 at 100° C. then is placed in the funnel and added to the flask over 30 minutes. The resulting reaction is continued for 1 hour at 45° C.

### EXAMPLE 12

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 70° C. ARCOL PG 2025 is placed into the addition funnel and is added over 90 minutes to react with the MI-30 in the flask. The resulting reaction is allowed to continue for 2 hours. Thionyl chloride (0.52 gm) is added. Molten E-22-2 at 100° C. then is placed in the funnel and added to the flask over 30 minutes. The resulting reaction is continued for 1 hour at 45° C.

### EXAMPLES 13-14

These Examples Illustrate the Use of an Amine that has Multiple Ethoxylations.

### EXAMPLE 13

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 70° C. ARCOL PG 2025 is placed into the addition funnel and is added over 90 minutes to react with the MI-30 in the flask. Molten E-22-2 then is placed in the funnel and added to the flask over 60 minutes. The resulting reaction is continued for 1 hour at 70° C.

### EXAMPLE 14

MI-30 is placed into a round-bottom flask equipped with a stir blade, stir bearing, stir shaft, addition funnel, nitrogen inlet, thermocouple, temperature controller, heating mantle, and a stopper. The MI-30 then is heated to 40° C. ARCOL PG 2025 is placed into the addition funnel and is added over 60 minutes to react with the MI-30 in the flask. Molten E-22-2 then is placed in the funnel and added to the flask over 60 minutes. The resulting reaction is continued for 1 hour.

### EXAMPLES 15-17

Examples 15-17 Illustrate Manufacture of Prepolymers from High Molecular Weight Ethoxylated Amines Such as E-22-2 and Triol Modified Polyols.

### EXAMPLE 15

MI-20 is placed into a round-bottom flask equipped with a stir blade, stir bearing, stir shaft, addition funnel, nitrogen inlet, thermocouple, temperature controller, heating mantle and a stopper. MI-20 is then heated to 70° C. ARCOL PPG-2025 is placed into the addition funnel and is added to the flask over 30 min. with vigorous stirring. ARCOL LG-56 is placed into the addition funnel and is added to the flask over 30 min, and let stirred for 1 h. Molten E-22-2 at 100° C. is placed into the addition funnel and is added to the flask over 30 min. The resulting reaction is allowed to continue for 2 h at 70° C.

### EXAMPLE 16

MI-20 (455.1 g) is placed into a round-bottom flask equipped with a stir blade, stir bearing, stir shaft, addition funnel, nitrogen inlet, thermocouple, temperature controller, heating mantle and a stopper. The MI-20 is then heated to 70° C. ARCOL PPG-2025 (206.6 g) is placed into the addition funnel and is added to the flask over 1 h with vigorous stirring. ARCOL LG-56 (68.8 g) is placed into the addition funnel and is added to the flask over 1 h. Molten E-22-2 (119.0 g) at 100° C. is placed into the addition funnel and is added to the flask over 30 min. The resulting reaction is allowed to continue for 1 h at 70° C.

### EXAMPLE 17

MI-50 (557.1 g) is placed into a round-bottom flask equipped with a stir blade, stir bearing, stir shaft, addition funnel, nitrogen inlet, thermocouple, temperature controller, heating mantle and a stopper. MI-50 is then heated to 70° C. Rubinol F-456 (231.9 g) is placed into the addition funnel and is added to the flask over 1.5 h with vigorous stirring. ARCOL LG-56 (77.3 g) is placed into the addition funnel and is added to the flask over 0.5 h, and let stirred for 1 h. E-22-2 (113.7 g) is placed into the addition funnel and is added to the flask over 30 min. The resulting reaction is allowed to continue for 2 h at 70° C.

### EXAMPLES 18-28

These Examples Illustrate Manufacture of Prepolymers from Reaction Systems Which Employ Propoxylated/Ethoxylated Ethylene Tetra-functional Diamines Such as SYNPERONIC T701 Which have a Molecular Weight Greater than 1000 g/mol.

### EXAMPLE 18

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 1.5 h. The resulting reaction is continued for 2 hours. Then, 0.52 gm thionyl chloride is added. SYNPERONIC T701 diamine is placed into the addition funnel and is added to the flask. The resulting reaction is allowed to continue for 2 h at 70° C.

### EXAMPLE 19

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 1.5 h. SYNPERONIC T701 diamine is placed into the addition funnel and is added to the flask over 1 h. The resulting reaction is allowed to continue for 2 h at 55° C.

### EXAMPLES 20-21

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 1 h. The resulting reaction mixture is stirred for 1 hour at 70° C. SYNPERONIC T701 is placed into the addition funnel and is added to the flask over 1 h. The mixture is reacted for 1 h at 70° C.

### EXAMPLE 22

MI-30 (386.9 gm) is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 (221.1 gm) is placed into the addition funnel and is added to the flask over 1.5 h. The resulting reaction mixture is stirred for 1 hour. SYNPERONIC T701 (192.0 gm) is placed into the addition funnel and is added to the flask over 1 h. The mixture is reacted for 1 h at 70° C.

### EXAMPLE 23

MI-50 (434.7 g) is placed into a round-bottom flask equipped with a stir blade, stir bearing, stir shaft, addition funnel, nitrogen inlet, thermocouple, temperature controller, heating mantle and a stopper. MI-50 is then heated to 80° C. ARCOL PPG-2025 (285.3 g) is placed into the addition funnel and is added to the flask over 1 h. SYNPERONIC T701 (180.0 g) is placed into the addition funnel and is added to the flask over 1 h. The mixture is reacted for 2 h at 80° C. Thionyl chloride(0.8 gm) then is added in one lot.

### EXAMPLES 24-27

These Examples Illustrate Manufacture of Prepolymers from Reaction Systems Which Employ Intermediate Molecular Weight Propoxylated/Ethoxylated Ethylene Diamines Such as SYNPERONIC T304

### EXAMPLES 24

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. Rubinol F-456 is placed into the addition funnel and is added to the flask over 1 h. SYNPERONIC T304 is placed into the addition funnel and is added to the flask over 1 h. The resulting mixture is reacted for 2 h at 70° C.

### EXAMPLE 25

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 1 h. SYNPERONIC T304 is placed into the addition funnel and is added to the flask over 1 h. The resulting mixture is reacted for 2 h at 70° C.

### EXAMPLE 26

MI-50(450.8 gm) is placed into a round-bottom flask equipped with a stir blade, stir bearing, stir shaft, addition funnel, nitrogen inlet, thermocouple, temperature controller, heating mantle and a stopper. MI-50 is then heated to 70° C. ARCOL PPG-2025 (341.1 gm) is placed into the addition funnel and is added to the flask over 1.5 h with vigorous stirring. Thionyl chloride in the amount of 0.8 gm is added to the flask. SYNPERONIC T304 in the amount of 108.1 gm is placed into the addition funnel and is added to the reactor over 1 h. The resulting reaction is allowed to continue for 2 h at 70° C.

### EXAMPLE 27

MI-50 (379.4 gm) is placed into a round-bottom flask equipped with a stir blade, stir bearing, stir shaft, addition funnel, nitrogen inlet, thermocouple, temperature controller, heating mantle and a stopper. ARCOL PPG-2025 (258.2 gm) is placed into the addition funnel and is added to the flask over 1.5 h with vigorous stirring. Thionyl chloride in the amount of 0.8 gm is added to the flask. SYNPERONIC T304 in the amount of 112.5 gm is placed into the addition funnel and is added to the reactor over 1.5 h. The resulting reaction is allowed to continue for 2 h.

### EXAMPLES 28-30

These Examples Illustrate the Effect of Propoxylated Ethylene Diamines Such as Dabco C1-485.

### EXAMPLE 28

MI-30 isocyanate(605.5 g) is placed into a round-bottom flask equipped with a stir blade, stir bearing, stir shaft, addition funnel, nitrogen inlet, thermocouple, temperature controller, heating mantle and a stopper. The MI-30 isocyanate is heated to 70° C. ARCOL PPG 3025 (76.5 g) is placed into the addition funnel and is added to the flask in one lot. ARCOL PPG 2025 (457.6 g) then is added over 30 m. The resulting reaction is allowed to continue for 3 h at 70° C. The resulting reaction system then is cooled to 40° C. and 72.8 gm DABCO CL-485 is added dropwise.

### EXAMPLE 29

MI-30 isocyanate(603.1 g) is placed into a round-bottom flask equipped with a stir blade, stir bearing, stir shaft, addition funnel, nitrogen inlet, thermocouple, temperature controller, heating mantle and a stopper. The MI-30 isocyanate is heated to 70° C. ARCOL PPG 3025 (80.6 g) is placed into the addition funnel and is added to the flask in one lot. ARCOL PPG 2025 (483.2 g) then is added over 30 m. The resulting reaction is allowed to continue for 4 h at 70° C. 35.8 gm DABCO CL-485 is added dropwise and the resulting reaction is continued for 1 h.

### EXAMPLE 30

MI-30 isocyanate is placed into a round-bottom flask equipped with a stir blade, stir bearing, stir shaft, addition funnel, nitrogen inlet, thermocouple, temperature controller, heating mantle and a stopper. The MI-30 isocyanate is heated to 70° C. ARCOL PPG 3025 is placed into the addition funnel and is added to the flask in one lot. ARCOL PPG 2025 then is added over 30 m. The resulting reaction is allowed to continue for 3.5 h at 70° C. The resulting reaction system is cooled to 23° C. and 72.8 gm DABCO CL-485 is added dropwise. Stir for one hour.

### EXAMPLE 31

This Example Illustrates Use of Prepolymers Mixtures.

In this example, Rubinate 9272 prepolymer is blended with Mondur XP-7080 prepolymer in a plastic container at room temperature.

### EXAMPLES 32-35

These Examples Illustrate the Use of Ethoxylated Tallow Amines.

### EXAMPLE 32

MI-30 isocyanate is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 60 min. with vigorous stirring. The resulting reaction mixture is continued for 1 h at 70° C. E-T-2 amine is placed into the addition funnel and added to the resulting reaction mixture over 1 h. The resulting reaction mixture is continued for 2 h at 70° C.

### EXAMPLE 33

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 30 min. with vigorous stirring. The resulting reaction mixture is heated at 70° C. for 30 min. E-T-2 amine is placed into the addition funnel and added to the resulting reaction mixture over 30 min. The resulting reaction mixture is cooled to 60° C. The resulting reaction mixture is continued for 2 h at 60° C.

### EXAMPLE 34

MI-30 is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 60 min. with vigorous stirring. The resulting reaction mixture is heated at 70° C. for 1 h. E-T-2 amine is placed into the addition funnel and added to the resulting reaction mixture over 1 h. The resulting reaction mixture is continued for 2 h at 70° C.

### EXAMPLE 35

MI-20 is placed into a round-bottom flask equipped with a stir blade, stir bearing, stir shaft, addition funnel, nitrogen inlet, thermocouple, temperature controller, heating mantle and a stopper. MI-20 is then heated to 70° C. ARCOL PPG-2025 is placed into the addition funnel and is added to the flask over 2 h. with vigorous stirring. The resulting reaction mixture is heated at 70° C. for 2 h. E-T-2 amine is placed into the addition funnel and added to the resulting reaction mixture over 1 h. The resulting reaction mixture is continued for 2 h at 70° C.

### COMPARISON EXAMPLES 36-38

These Examples Illustrate the Effect of Non-EO Propoxylated Tallow Amines Such as Propomeen T12.

### EXAMPLE 36

MI-30 isocyanate is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 2 h with vigorous stirring. The resulting reaction mixture is continued for 2 h at 70° C. Propomeen T12 amine is placed into the addition funnel and added to the resulting reaction mixture over 1 h. The resulting reaction mixture is continued for 1 h at 70° C.

### EXAMPLE 37

MI-30 isocyanate is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL E-381 is placed into the addition funnel and is added to the flask over 2 h with vigorous stirring. Propomeen T12 amine is placed into the addition funnel and added to the resulting reaction mixture over 1 h. The resulting reaction mixture is continued for 2 h at 70° C.

### EXAMPLE 38

MI-30 isocyanate is placed into a round-bottom flask equipped with a stir blade, stir bearing, stir shaft, addition funnel, nitrogen inlet, thermocouple, temperature controller, heating mantle and a stopper. MI-30 is then heated to 70° C. ARCOL PPG-2025 is placed into the addition funnel and is added to the flask over 2 h with vigorous stirring. The resulting reaction mixture is continued for 1 h at 70° C. Propomeen T12 amine is placed into the addition funnel and added to the resulting reaction mixture over 1 h. The resulting reaction mixture is continued for 1 h at 70° C.

### EXAMPLES 39-41

These Examples Illustrate the Use of Ethoxylated Octyl Amines.

### EXAMPLE 39

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. Arcol PPG-2025 polyol is placed into the addition funnel. The polyol is added over 1 h with vigorous stirring and reacted for one hour at 70° C. Chemeen 8-2 amine is placed into the addition funnel and added to the flask over 30 min. The resulting reaction is allowed to continue for 1 hr at 70° C.

### EXAMPLE 40

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. RUBINOL F-456 is placed into the addition funnel. The polyol is added over 1 h with vigorous stirring. The reaction is stirred for 2 h. Chemeen 8-2 amine is placed into the addition funnel and added to the flask over 30 min. The resulting reaction is allowed to continue for 1 hr at 70° C.

### EXAMPLE 41

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. Rubinol F-456 polyol is placed into the addition funnel. The polyol is added over 30 min with vigorous stirring and reacted for two hours at 70° C. Chemeen 8-2 amine is placed into the addition funnel and added to the flask over 30 min. The resulting reaction is allowed to continue for 1 hr at 70° C.

### EXAMPLES 42-45

These Examples Illustrate Use of Methyldiethanol Amines.

### EXAMPLE 42

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. Arcol PPG-2025 polyol is placed into the addition funnel. The polyol is added over 1 h with vigorous stirring and reacted for two hour. Methyldiethanol amine is placed into the addition funnel and added to the flask over 30 min. The resulting reaction is allowed to continue for 1 hr.

### EXAMPLE 43

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. Arcol PPG-2025 polyol is placed into the addition funnel. The polyol is added over 1 h with vigorous stirring and reacted for two hour. Methyldiethanol amine is placed into the addition funnel and added to the flask over 30 min. The resulting reaction is allowed to continue for 1 hr.

### EXAMPLE 44

MI-30 is placed into a round bottom flask equipped with a stir blade, stir bearing, stir shaft, addition funnel, nitrogen inlet, thermocouple, temperature controller, heating mantle and a stopper. The MI-30 is heated to 70° C. Arcol PPG-2025 polyol is placed into the addition funnel. The polyol is added over 1 h with vigorous stirring and reacted for two hour at 70° C. Methyldiethanol amine is placed into the addition funnel and added to the flask over 15 min. The resulting reaction is allowed to continue for 1 hr at 70° C.

### EXAMPLE 45

MI-20 is placed into a round bottom flask equipped with a stir blade, stir bearing, stir shaft, addition funnel, nitrogen inlet, thermocouple, temperature controller, heating mantle and a stopper. The MI-20 is heated to 70° C. Arcol PPG-2025 is placed into the addition funnel and is added to the flask over 1.5 h with vigorous stirring and reacted for 2 h at 70° C. Methyldiethanol amine is placed into the addition funnel and added to the flask over 10 min. The resulting reaction is allowed to continue for 30 min at 70° C.

### COMPARISON EXAMPLES 46-49

These Examples Illustrate the Effect of Use of Triethanolamine.

### EXAMPLE 46

In a 2 L round bottom flask equipped with a stir blade, stir bearing, stir shaft, addition funnel, nitrogen inlet, thermocouple, temperature controller, heating mantle and a stopper is placed MI-30 (470.6 g). The MI-30 is heated to 70° C. Arcol PPG-2025 polyol(309.4 g) is placed into the addition funnel. The polyol is added over 1.5 hours with vigorous stirring. The resulting reaction mixture is stirred for two hours at 70° C. Triethanol amine in an amount of 20.0 gm is placed into the addition funnel and added to the flask over 15 min. The resulting reaction is allowed to continue for 1 hr at 70° C. The resulting prepolymer formed 2 layers, thereby representing an unstable prepolymer.

### EXAMPLE 47

In a 2 L round bottom flask equipped with a stir blade, stir bearing, stir shaft, addition funnel, nitrogen inlet, thermocouple, temperature controller, heating mantle and a stopper is placed MI-30 (496.2 g). The MI-30 is heated to 70° C. Arcol PPG-2025 (271.9 g) polyol is placed into the addition funnel. The polyol is added over 2.0 hours with vigorous stirring. The resulting reaction mixture is stirred for one hour. Triethanol amine in an amount of 32.0 gm is placed into the addition funnel and added to the flask over 60 min. The resulting reaction is allowed to continue for 1 hr. The resulting prepolymer formed 2 layers, thereby representing an unstable prepolymer.

### EXAMPLE 48

In a 2 L round bottom flask equipped with a stir blade, stir bearing, stir shaft, addition funnel, nitrogen inlet, thermocouple, temperature controller, heating mantle and a stopper is placed MI-30 (530.4 g). Arcol PPG-2025 polyol(221.6 g) is placed into the addition funnel. The polyol is added over 1.5 hours with vigorous stirring. Triethanol amine in an amount of 47.9 gm is placed into the addition funnel and added to the flask over 60 min. The resulting reaction is allowed to continue for 1 hr at 70° C. The resulting prepolymer solidified after 12 days at 45° C., thereby representing an unstable prepolymer. Moisture cured films of the prepolymer bubbled at 20° F. and at room temperature.

### EXAMPLE 49

In a 2 L round bottom flask equipped with a stir blade, stir bearing, stir shaft, addition funnel, nitrogen inlet, thermocouple, temperature controller, heating mantle and a stopper is placed MI-30 (550.2 g). Arcol PPG-4025 (248.8 g) is placed into the addition funnel. The polyol is added over 1.5 hours with vigorous stirring, and the resulting reaction mixture then is cooled to 40° C. 0.52 gm of thionyl chloride is added to the prepolymer. Triethanol amine (50.9 gm) is placed into the addition funnel and added to the prepolymer over 30 min. The resulting reaction mixture is stirred for 1 hr at 70° C. The resulting prepolymer solidified after 3 days at 50° C., thereby representing an unstable prepolymer. Moisture cured films of the prepolymer bubbled at 20° F. and at room temperature.

### COMPARISON EXAMPLE 50

This Example Illustrates Use of Non-EO Amines With EO Polyols

In a 2 L round bottom flask equipped with a stir blade, stir shaft, stir bearing, addition funnel, nitrogen inlet, thermocouple, temperature controller, heating mantle and a stopper is placed MI-30 (236.1 g). The MI-30 then is heated to 70° C. PEG-1450(91.77 g, polyethylene glycol, MW=1450) is placed into the addition funnel. The PEG-1450 is added to the flask over 30 m. The mixture is allowed to stir for 1 h. Propomeen T/12 amine (72.11 g) is placed into the addition funnel. The Propomeen T/12 amine is added to the mixture over 30 m. The resulting prepolymer is stirred for 2 h at 70° C.

A thin film (5 mil) of the prepolymer is placed on a sheet of glass with a thin film applicator. The film is placed in a 40° F. refrigerator. After 20 h, the film is tacky and uncured.

TABLE 1

| | Arcol | Arcol | Arcol | | | | | | | | | |
|---|---|---|---|---|---|---|---|---|---|---|---|---|
| Ex./ | PPG- | PPG- | LG-56 | Rubinol | | | | Dabco | | | | Viscosity of |
| Component | 2025 | 3025 | Triol | F 456 | E-T-2¹ | E-18-2 | E-22-2 | CL 485 | T701¹ | T304² | Isocyanate | Prepolymer |
| 1 | 27.2% | 0% | 0% | 0% | 18.2% | 0% | 0% | 0% | 0% | 0% | MI-30: 54.6% | 4312 cps |
| 2 | 40.5 | 0 | 0 | 0 | 7.2 | 0 | 0 | 0 | 0 | 0 | MI-30: 52.3 | 1342 |
| 3 | 35.1 | 0 | 0 | 0 | 11.7 | 0 | 0 | 0 | 0 | 0 | MI-30: 53.2 | 2024 |
| 4 | 29.6 | 0 | 0 | 0 | 14.0 | 0 | 0 | 0 | 0 | 0 | MI-30: 56.4 | 2160 |
| 5 | 27.2 | 0 | 0 | 0 | 0 | 18.2 | 0 | 0 | 0 | 0 | MI-30: 54.6 | 4780 |
| 6 | 35.1 | 0 | 0 | 0 | 0 | 11.7 | 0 | 0 | 0 | 0 | MI-30: 53.2 | 2200 |
| 7 | 40.5 | 0 | 0 | 0 | 0 | 7.2 | 0 | 0 | 0 | 0 | MI-30: 52.3 | 1366 |
| 8 | 35.0 | 0 | 0 | 0 | 0 | 11.7 | 0 | 0 | 0 | 0 | MI-50: 53.2 | 2560 |
| 9 | 33.2 | 0 | 0 | 0 | 0 | 0 | 15.0 | 0 | 0 | 0 | MI-30: 51.8 | 3100 |
| 10 | 32 5 | 0 | 0 | 0 | 0 | 0 | 13.0 | 0 | 0 | 0 | MI-30: 54.5 | 2090 |
| 11 | 36.6 | 0 | 0 | 0 | 0 | 0 | 10.0 | 0 | 0 | 0 | MI-30: 53.4 | 1750 |
| 12 | 39.4 | 0 | 0 | 0 | 0 | 0 | 10.8 | 0 | 0 | 0 | MI-30: 49.7 | 1950 |
| 13 | 26.6 | 0 | 0 | 0 | 0 | 0 | 15.0 | 0 | 0 | 0 | MI-30: 58.4 | 1450 |
| 14 | 20.0 | 0 | 0 | 0 | 0 | 0 | 20.0 | 0 | 0 | 0 | MI-30: 60.0 | 1320 |
| 15 | 16.2 | 0 | 16.2 | 0 | 0 | 0 | 14.0 | 0 | 0 | 0 | MI-20: 53.6 | 3300 |
| 16 | 24.3 | 0 | 8.1 | 0 | 0 | 0 | 14.0 | 0 | 0 | 0 | MI-20: 53.6 | 2800 |
| 17 | 0 | 0 | 7.7 | 23.2 | 0 | 0 | 13.4 | 0 | 0 | 0 | MI-50: 55.7 | 2250 |
| 18 | 45.8 | 0 | 0 | 0 | 0 | 0 | 0 | 0 | 6.0 | 0 | MI-30: 48.2 | 1050 |
| 19 | 39.7 | 0 | 0 | 0 | 0 | 0 | 0 | 0 | 12.0 | 0 | MI-30: 48.3 | 1300 |
| 20 | 33.7 | 0 | 0 | 0 | 0 | 0 | 0 | 0 | 18.0 | 0 | MI-30: 48.3 | 1640 |
| 21 | 31.7 | 0 | 0 | 0 | 0 | 0 | 0 | 0 | 20.0 | 0 | MI-30: 48.3 | |
| 22 | 27.6% | 0% | 0% | 0% | 0% | 0% | 0% | 0% | 24.0% | 0% | MI-30: 48.4 | 1570 cps |
| 23 | 31.7 | 0 | 0 | 0 | 0 | 0 | 0 | 0 | 20 | 0 | MI-50: 48.2 | 2670 |
| 24 | 0 | 0 | 0 | 35.6 | 0 | 0 | 0 | 0 | 0 | 14.0 | MI-30: 50.4 | 1770 |
| 25 | 40.2 | 0 | 0 | 0 | 0 | 0 | 0 | 0 | 0 | 10.0 | MI-30: 49.8 | 2400 |
| 26 | 37.9 | 0 | 0 | 0 | 0 | 0 | 0 | 0 | 0 | 12.0 | MI-50: 50.0 | 2500 |
| 27 | 34.4 | 0 | 0 | 0 | 0 | 0 | 0 | 0 | 0 | 15.0 | MI-50: 50.5 | 3000 |
| 28 | 37.7 | 6.3 | 0 | 0 | 0 | 0 | 0 | 6.0 | 0 | 0 | MI-30: 49.9 | 25954 |
| 29 | 40.2 | 6.7 | 0 | 0 | 0 | 0 | 0 | 3.0 | 0 | 0 | MI-30: 50.1 | 3299 |
| 30 | 41.2 | 6.9 | 0 | 0 | 0 | 0 | 0 | 1.5 | 0 | 0 | MI-30: 50.4 | 1416 |

¹Synperonic T 701
²Synperonic T 304

TABLE 1A

| | Arcol | Arcol | | | | | | | | | |
|---|---|---|---|---|---|---|---|---|---|---|---|
| Ex./ | PPG- | PPG- | Arcol | Rubinol | | | Dabco | | | | Viscosity of |
| Component | 2025 | 3025 | E-381 | F456 | E-T-2 | P-T12¹ | CL 485 | C-8-2² | C-1-2³ | Isocyanate % | Prepolymer |
| 31 | 0% | 0% | 0% | 0% | 0% | 0% | 0% | 0% | 0% | Blend of 90 wt. | |
| | | | | | | | | | | % Mondur | |
| | | | | | | | | | | XP7080 and 10 | |
| | | | | | | | | | | wt. % Rubinate | |
| | | | | | | | | | | 9272 | |
| 32 | 31.4 | 0 | 0 | 0 | 14.7 | 0 | 0 | 0 | 0 | MI-30: 53.9 | |
| 33 | 40.5 | 0 | 0 | 0 | 7.2 | 0 | 0 | 0 | 0 | MI-30: 52.3 | |
| 34 | 27.1 | 0 | 0 | 0 | 12.8 | 0 | 0 | 0 | 0 | MI-30: 60.1 | 1179 |
| 35 | 31.4 | 0 | 0 | 0 | 14.8 | 0 | 0 | 0 | 0 | MI-20: 53.9 | |
| 36 | 31.6 | 0 | 0 | 0 | 0 | 14.9 | 0 | 0 | 0 | MI-30: 53.5 | |
| 37 | 0 | 0 | 31.6 | 0 | 0 | 14.9 | 0 | 0 | 0 | MI-30: 53.5 | |
| 38 | 22.8 | 0 | 0 | 0 | 0 | 18.7 | 0 | 0 | 0 | MI-30: 58.5 | |
| 39 | 37.2 | 0 | 0 | 0 | 0 | 0 | 0 | 7.6 | 0 | MI-30: 55.2 | |
| 40 | 0 | 0 | 0 | 42.4 | 0 | 0 | 0 | 4.9 | 0 | MI-30: 52.7 | 2000 |
| 41 | 0 | 0 | 0 | 45.3 | 0 | 0 | 0 | 3.4 | 0 | MI-30: 51.3 | 1515 |
| 42 | 44.9 | 0 | 0 | 0 | 0 | 0 | 0 | 0 | 2.5 | MI-30: 52.6 | |
| 43 | 48.3 | 0 | 0 | 0 | 0 | 0 | 0 | 0 | 1.25 | MI-30: 50.4 | 1434 |
| 44 | 49.8 | 0 | 0 | 0 | 0 | 0 | 0 | 0 | 0.8 | MI-30: 49.5 | 1416 |
| 45 | 49.1 | 0 | 0 | 0 | 0 | 0 | 0 | 0 | 1.0 | MI-20: 49.9 | |

¹Propomeen T12
²Chemeen 8-2
³Methyl diethanol amine

Manufacture of Prepolymer Film

The prepolymers of the invention advantageously can be used to produce films of various thicknesses which moisture cure within 24 hours at 20° F. The thicknesses of the films may vary from about 203μ to about 254μ, preferably about 127μ.

Films of the prepolymers produced in the examples above are made by applying a bead of the prepolymer to a sheet of clean glass. The beads are leveled into thin films with a doctors knife (GARDCO adjustable micrometer film applicator). The thicknesses of the films are measured with a GARDCO wet film thickness gauge. The films are made to have a thickness less than about 127μ thickness. The films are allowed to react with atmospheric moisture for several days. The films are removed from the glass by immersion into hot water. After several minutes the films are gently pulled from the glass. The films are moisture-cured on 152.4 mm×203.2 mm sheets of glass at 20° F. and 73° F.

The physical properties of the films produced are shown in Tables 2. In Table 2, the tensile strengths and maximum elongations of the thin films are measured by ASTM D882-91. The tear resistances are measured by ASTM test method D624-91 (Die C). Taber Abrasions are measured using ASTM test method D1044-90 and a CS-17 Taber wheel. The weight lost after 500 and 1000 revolutions is measured. Water absorption is determined using ASTM D-570-95.

As shown in Table 2, films produced with use of E-T-2 amine produced the highest tensile strengths and the highest elongations.

TABLE 2
Properties

| | | | | | Taber Abrasion | | |
|---|---|---|---|---|---|---|---|
| | | Condition of | | Condition of | 500 cycles, | Tensile @ | Tensile @ |
| Ex./ | Film Cure at | 5 mil Film at | Film Cure at | 5 mil Film at | 20F. cure | 25C. of Film | 25C. of Film |
| Component | 25C. in 24 Hr | 25C. in 24 Hr | 20F. in 24 Hr | 20F. in 24 Hr | (Wt. Loss Mg) | Cured at 20F. PSI | Cured at 25C. PSI |
| 1 | Yes | Void Free | Yes | Void Free | — | — | 3670 |
| 2 | Yes | Void Free | No | Void Free | — | 6010 | 4204 |
| 3 | Yes-hazy | Void Free | Almost | Void Free | — | 7773 | 4888 |
| 4 | Yes-hazy | Void Free | Almost | Void Free | — | 4581 | 4214 |
| | | | Creasable | | | | |
| 5 | Yes-Clear | Void Free | Yes | Void Free | — | 4212 | 6498 |
| 6 | Yes-hazy | Void Free | Yes | Void Free | 8.8 | 8681 | 4959 |
| 7 | Yes | Void Free | Tacky | Void Free | — | 5749 | 3081 |
| 8 | Cured | — | Cured | — | — | 3903 | 4250 |
| 9 | — | — | Yes | — | — | 3624 | — |
| 10 | — | — | Almost | — | — | 4699 | 2007 |
| 11 | — | — | No | — | — | 5201 | |
| 12 | — | — | Tacky- | — | — | 5725 | 2403 |
| | | | Writable | | | | |
| 13 | — | — | Almost | — | — | — | — |
| 14 | — | — | Yes | — | — | — | — |
| 15 | — | — | Cured | — | — | 4119 | 3007 |
| 16 | — | — | Cured | — | — | 4951 | — |
| 17 | — | — | Cured | Void Free | — | 7116 | 6755 |
| 18 | — | — | No | — | — | 2433 | 1970 |
| 19 | — | — | Tacky | — | — | 3834 | 2335 |
| 20 | — | — | Slightly | — | — | 3897 | 2620 |
| | | | Scratchable | | | | |
| 21 | — | — | Yes | — | — | 4755 | 2498 |
| 22 | — | — | Yes | — | — | 4097 | 2893 |
| 23 | — | — | Cured | — | — | 4647 | 4152 |
| 24 | — | — | Yes | — | — | 5625 | 4476 |
| 25 | — | — | Yes | — | — | 6525 | 5218 |
| 26 | — | — | Yes/ | Void Free | — | 5740 | 5465 |
| | | | Writable | | | | |
| 27 | — | — | Cured | — | — | 4470 | 3523 |
| 28 | — | — | Tacky | — | — | 4959 | 5485 |
| 29 | — | — | No | — | — | 5150 | 3515 |
| 30 | — | — | Uncured | — | — | 3702 | 3851 |
| 31 | — | Void Free | Slightly | — | 3.9 | 6301 | 7110 |
| | | | Creasable | | | | |
| 32 | Yes | Void Free | Slightly | Void Free | — | 5311 | 4022 |
| | | | Creasable | | | | |
| 33 | Yes | Void Free | No | Void Free | — | 6010 | 4204 |
| 34 | Yes | Void Free | Yes | Void Free | — | 7200 | 6173 |
| 35 | Yes | Void Free | Tacky | Void Free | — | — | — |
| 36 | Yes | Void Free | Tacky | — | — | 10071 | 15854 |
| 37 | Yes | — | Tacky | — | — | 8896 | 12694 |
| 38 | Yes | — | — | — | — | 5978 | 2059 |
| 39 | Yes | Void Free | Yes | Clear | — | 7726 | 6206 |
| 40 | Yes | Void Free | Yes | Clear | — | 11494 | 7087 |
| 41 | Yes | Void Free | No | Clear | — | 10202 | 6284 |
| 42 | Yes | Void Free | Yes | Clear | — | 2816 | 5941 |
| 43 | Yes | Void Free | Yes | Clear | — | 8007 | 7537 |
| 44 | Yes | Void Free | No | Clear | — | 4847 | 2393 |
| 45 | Yes | — | indentable | — | — | 6977 | 2667 |

| | Max. Elong. @ | Max. Elong. @ | Tear Resistance | |
|---|---|---|---|---|
| Ex./ | 25C. of Film | 25C. of Film | @ 25C. of Film | Tear Resistance |
| Component | Cured at 20F., % | Cured at 25C. % | Cured at 20F. Pli | at 25C. Pli |
| 1 | — | 144 | — | — |
| 2 | 239.0 | 189 | 900 | 1112 |
| 3 | 264 | 226 | 1091 | 668 |
| 4 | 69.8 | 153 | 787 | 856 |
| 5 | 103.0 | 228 | 643 | 757 |
| 6 | 264.0 | 194 | 776 | 1073 |
| 7 | 247.0 | 166 | 1019 | 700 |
| 8 | 255 | 263 | 1006 | 960 |
| 9 | 216.0 | — | — | 580 |
| 10 | 253.0 | 25.9 | 582 | — |
| 11 | 284.0 | — | 631 | — |
| 12 | 273.0 | 183 | 612 | 303 |
| 13 | — | — | — | — |
| 14 | — | — | — | — |
| 15 | 195.0 | 145.6 | 624 | 613 |
| 16 | 132 | — | 753 | — |
| 17 | 309 | 183 | — | — |
| 18 | 190.6 | 141 | 469 | 418 |
| 19 | 278.5 | 168.3 | 384 | 371 |
| 20 | 247.4 | 168.0 | 464.0 | 349.0 |
| 21 | 249.9 | 179.8 | 785.0 | 565.0 |
| 22 | 248.8 | 189.6 | 581.0 | 636.0 |
| 23 | 264 | 310 | 493 | 345 |
| 24 | 187.4 | 147.6 | 911.0 | 1012 |
| 25 | 127.7 | 143.1 | 1315 | 802 |
| 26 | 230.4 | 225 | 884 | 850 |
| 27 | 174.3 | 127.6 | 815 | 993 |
| 28 | 47.4 | 35.8 | — | — |
| 29 | 116.0 | 87.3 | — | — |
| 30 | 146.0 | 96.4 | | |
| 31 | 152 | 180 | 739 | 927 |
| 32 | 168 | 190 | — | 1068 |
| 33 | 239 | 189 | 900 | 1112 |
| 34 | 4.91 | 6.36 | 1157 | 1176 |
| 35 | — | — | — | — |
| 36 | 129 | 82.8 | 824 | 885 |
| 37 | 180 | 148 | — | — |
| 38 | 2.6 | 2.7 | 438 | 206 |
| 39 | 126 | 163 | 2178 | 1972 |
| 40 | 268 | 248 | 1146 | 1298 |
| 41 | 267 | 274 | 1911 | 956 |
| 42 | 210 | 270 | 1110 | 901 |
| 43 | 203 | 259 | 797 | 613 |
| 44 | 297 | 168 | 917 | 521 |
| 45 | 278 | 211 | 703 | 414 |

GENERAL CONCLUSIONS RE THE AMINES USED

| AMINE¹ | NO CURE | ALMOST CURE | CURED |
|---|---|---|---|
| E-T-2 | 199/387 | 325/325 | 505 |
| E-18-2 | 199 | | 505/325/324 |
| E-22-2 | 222 | 289 | 333/311/311/297 |
| E-18-8 | | 246 | 328 |
| T701 | 32.8/66 | 98 | 110/132/110 |
| T304 | | 121 | 170/145/181 |
| P-T-2 | 394/394 | | |
| C-8 | 157 | | |
| C-1 | 63/84/64 | | 211/105 |

¹All amounts are expressed as: [(mols amine/gm prepolymer) × 10⁶]

1. A reaction system for preparing prepolymer comprising:
a. polyol;
b. isocyanate; and
c. at least di-functional, aliphatic tertiary amine having at least one EO group on the nitrogen atom of the amine.

2. The reaction system of claim 1, wherein the at least difunctional, aliphatic tertiary amine is selected from the group consisting of C-5 amines, difunctional C-18 amines, difunctional C-22 amines, tetra-functional propoxylated/ethoxylated ethylene diamines, and combinations thereof.

3. The reaction system of claim 1, wherein the amine contains one or more alkyl groups.

4. The reaction system of claim 3, wherein the alkyl groups contain from 1 to 22 carbon atoms.

5. The reaction system of claim 1, wherein the polyol is selected from the group consisting of polyester polyols, polyether diols, polyether triols, and combinations thereof.

6. The reaction system of claim 1, wherein the isocyanate is selected from the group consisting of 4,4 MDI and blends of 4,4 MDI with 2,4 MDI.

7. The reaction system of claim 1, wherein the isocyanate is selected from the group consisting of 3,3′-dimethyl-4,4′-diphenylenediisocyanate, 3,3′-dimethoxy-4,4′-bisphenylenediisocyanate, 3,3′-diphenyl-4,4′-biphenylenediisocyanate, 4,4′-biphenylene diisocyanate, 4-chloro-1,3-phenylene diisocyanate, 3,3′-dichloro-4,4′-biphenylene diisocyanate, 1,5-naphthalene diisocyanate, o- and p-methoxy isocyanate, o-diisocyanate benzyl chloride, octyl diisocyanate, octadecyl diisocyanate, ethylene diisocyanate, 1,4-tetramethylene diisocyanate, 1,6-hexamethylene diisocyanate, 2,4,4-tri-methyl-1,6-hexamethylene diisocyanate, 1,12-dodecane diisocyanate, cyclohexyl diisocyanate, cyclohexane-1,4-diisocyanate, cyclobutane-1,3-diisocyanate, cyclohexane-1,3-diisocyanate, 1-isocyanato-2-isocyanatomethly cyclopentane, 1-isocyanato-3,3,5-trimethyl-5-isocanatomethyl cyclohexane, 2,4′-dicyclohexylhexylmethane diisocyanate, 4,4′-dicyclohexylmethane diisocyanate, and combinations thereof.

8. The reaction system of claim 1, wherein two EO groups are attached to the nitrogen atom of the amine.

9. The reaction system of claim 1, wherein the amine is represented by the formula —NR₁R₂R₃, where R₁, R₂, and R₃ may be the same or different and may be any of substituted or unsubstituted alkyl, substituted or unsubstituted alkene, or substituted or unsubstituted alkyne, and at least one of R₁, R₂, and R₃ contains EO moieties.

10. A prepolymer prepared from the reaction system of claim 1.

11. The prepolymer of claim 10, wherein the prepolymer moisture-cures in less than about 24 hours at 20 F and has a functionality of about 1.6 to about 2.4.

12. The prepolymer of claim 11, wherein the prepolymer has a functionality of about 2.0 to about 2.2.

13. The prepolymer of claim 12, wherein the prepolymer has a functionality of about 2.0 to about 2.05.

14. The prepolymer of claim 10, wherein the prepolymer has a room temperature viscosity of about 1000 cps to about 6000 cps.

15. The prepolymer of claim 10, wherein the prepolymer has an NCO content of about 6% to about 20%.

16. A method for forming a prepolymer comprising: stirring together a.) polyol; b.) isocyanate; and c.) at least difunctional, aliphatic tertiary amine having at least one EO group on the nitrogen atom of the amine.

17. The method of claim 16, wherein, the at least difunctional, aliphatic tertiary amine is selected from the group consisting of C-5 amines, difunctional C-18 amines, difunctional C-22 amines, tetra-functional propoxylated/ethoxylated ethylene diamines, and combinations thereof.

18. The method of claim 16, wherein the amine contains one or more alkyl groups.

19. The method of claim 18, wherein the alkyl groups contain from 1 to 22 carbon atoms.

20. The method of claim 16, wherein the polyol is selected from the group consisting of polyester polyols, polyether diols, polyether triols, and combinations thereof.

21. The method of claim 16, wherein the isocyanate is selected from the group consisting of 4,4 MDI and blends of 4,4 MDI with 2,4 MDI.

22. The method of claim 16, wherein the isocyanate is selected from the group consisting of 3,3′-dimethyl-4,4′-diphenylenediisocyanate, 3,3′-dimethoxy-4,4′-bisphenylenediisocyanate, 3,3′-diphenyl-4,4′-biphenylenediisocyanate, 4,4′-biphenylene diisocyanate, 4-chloro-1,3-phenylene diisocyanate, 3,3′-dichloro-4,4′biphenylene diisocyanate, 1,5-naphthalene diisocyanate, o- and p-methoxy isocyanate, o-diisocyanate benzyl chloride, octyl diisocyanate, octadecyl diisocyanate, ethylene diisocyanate, 1,4-tetramethylene diisocyanate, 1,6-hexamethylene diisocyanate, 2,4,4-tri-methyl-1,6-hexamethylene diisocyanate, 1,12-dodecane diisocyanate, cyclohexyl diisocyanate, cyclohexane-1,4-diisocyanate, cyclobutane-1,3-diisocyanate, cyclohexane-1,3-diisocyanate, l-isocyanato-2-isocyanatomethly cyclopentane, 1-isocyanato-3,3,5-trimethyl-5-isocanatomethyl cyclohexane, 2,4′-dicyclohexylhexylmethane diisocyanate, 4,4′-dicyclohexylmethane diisocyanate, and combinations thereof.

23. The method of claim 16, wherein two EO groups are attached to the nitrogen atom of the amine.

24. The method of claim 16, wherein the amine is represented by the formula —NR₁R₂R₃, where R₁, R₂, and R₃ may be the same or different and may be any of substituted or unsubstituted alkyl, substituted or unsubstituted alkene, or substituted or unsubstituted alkyne, and at least one of R₁, R₂, and R₃ contains EO moieties.

25. A prepolymer prepared by the method of claim 16.

26. The method of claim 16, wherein the prepolymer moisture-cures in less than about 24 hours at 20 F and has a functionality of about 1.6 to about 2.4.

27. The method of claim 26, wherein the prepolymer has a functionality of about 2.0 to about 2.2.

28. The method of claim 27, wherein the prepolymer has a functionality of about 2.0 to about 2.05.

29. The method of claim 16, wherein the prepolymer has a room temperature viscosity of about 1000 cps to about 6000 cps.

30. The method of claim 16, wherein the prepolymer has an NCO content of about 6% to about 20%.
